(19) United States
(12) Patent Application Publication
(10) Pub. No.: US 2019/0370176 A1
(43) Pub. Date: Dec. 5, 2019

(54) ADAPTIVELY PREDICTING USEFULNESS OF PREFETCHES GENERATED BY HARDWARE PREFETCH ENGINES IN PROCESSOR-BASED DEVICES

(71) Applicant: QUALCOMM Incorporated, San Diego, CA (US)

(72) Inventors: Shivam Priyadarshi, Morrisville, NC (US); Niket Choudhary, Bangalore (IN); David Scott Ray, Raleigh, NC (US); Thomas Philip Speier, Wake Forest, NC (US)

(21) Appl. No.: 15/995,993

(22) Filed: Jun. 1, 2018

(51) Int. Cl. G06F 12/0862; G06F 12/0893; G06F 12/0891

(52) U.S. Cl. CPC G06F 12/0862; G06F 2212/602; G06F 12/0891; G06F 12/0893

(57) ABSTRACT

Adaptively predicting usefulness of prefetches generated by hardware prefetch engines of processor-based devices is disclosed. In this regard, a processor-based device provides a hardware prefetch engine including a sampler circuit and a predictor circuit. The sampler circuit stores data related to demand requests and prefetch requests directed to memory addresses corresponding to a subset of sets of a cache of the processor-based device. The predictor circuit includes a plurality of confidence counters that correspond to the memory addresses tracked by the sampler circuit, and that indicate a level of confidence in the usefulness of the corresponding memory addresses. The confidence counters provided by the predictor circuit are trained in response to demand request hits and misses (and, in some aspects, prefetch misses) on the memory addresses tracked by the sampler circuit. The predictor circuit may then use the confidence counters to generate usefulness predictions for subsequent prefetch requests.

### BACKGROUND

### I. Field of the Disclosure

The technology of the disclosure relates generally to cache memory provided by processor-based devices, and, in particular, to prefetching cache lines by hardware prefetcher engines.

### II. Background

In many conventional processor-based devices, overall system performance may be constrained by memory access latency, which refers to the time required to request and retrieve data from relatively slow system memory. The effects of memory access latency may be mitigated somewhat through the use of one or more caches by a processor-based device to store and provide speedier access to frequently-accessed data. For instance, when data requested by a memory access request is present in a cache (i.e., a cache “hit”), system performance may be improved by retrieving the data from the cache instead of the slower system memory. Conversely, if the requested data is not found in the cache (resulting in a cache “miss”), the requested data then must be read from the system memory. As a result, frequent occurrences of cache misses may result in system performance degradation that could negate the advantage of using the cache in the first place.

To reduce the likelihood of cache misses, the processor-based device may provide a hardware prefetch engine (also referred to as a “prefetch circuit” or simply a “prefetcher”). The hardware prefetch engine may improve system performance of the processor-based device by predicting a subsequent memory access and prefetching the corresponding data prior to an actual memory access request being made. For example, in systems that tend to exhibit spatial locality, the hardware prefetch engine may be configured to prefetch data from a next memory address after the memory address of a current memory access request. The prefetched data may then be inserted into one or more cache lines of a cache. If the hardware prefetch engine successfully predicted the subsequent memory access, the corresponding data can be immediately retrieved from the cache.

However, inaccurate prefetches generated by the hardware prefetch engine may negatively impact system performance in a number of ways. For example, prefetched data that is not actually useful (i.e., no subsequent memory access requests are directed to the prefetched data) may pollute the cache by causing the eviction of cache lines storing useful. The prefetching operations performed by the hardware prefetch engine may also increase consumption of power and memory bandwidth, without the benefit of the prefetched data being useful. Thus, it is desirable to provide a mechanism to increase the likelihood that data prefetched by the hardware prefetch engine will prove useful.

### SUMMARY OF THE DISCLOSURE

Aspects disclosed in the detailed description include adaptively predicting usefulness of prefetches generated by hardware prefetch engines in processor-based devices. In this regard, in some aspects, a processor-based device provides a hardware prefetch engine that includes a sampler circuit and a predictor circuit. The sampler circuit is configured to store data related to demand requests and prefetch requests that are directed to a subset of sets of a cache of the processor-based device. The sampler circuit maintains a plurality of sampler set entries, each of which corresponds to a set of the cache and includes a plurality of sampler line entries corresponding to memory addresses of the set. Each sampler line entry comprises a prefetch indicator that indicates whether the corresponding memory line was added to the sampler circuit in response to a prefetch request or a demand request. The predictor circuit includes a plurality of confidence counters that correspond to the sampler line entries of the sampler circuit, and that indicate a level of confidence in the usefulness of the corresponding sampler line entry. The confidence counters provided by the predictor circuit are trained in response to demand request hits and misses (and, in some aspects, on prefetch misses) on the memory lines tracked by the sampler circuit. In particular, on a demand line hit corresponding to a sampler line entry, the predictor circuit increments the confidence counter corresponding to a sampler line entry if the prefetch indicator of the sampler line entry is set (thus indicating that the memory line was populated by a prefetch request). Similarly, on a demand line miss, the predictor circuit decrements the confidence counter associated with a sampler line entry corresponding to an evicted memory line if the prefetch indicator of the sampler line entry is set. The predictor circuit may then use the confidence counters to generate a usefulness prediction for a subsequent prefetch request corresponding to a sampler line entry of the sampler circuit. In some aspects, the hardware prefetch engine may further provide an adaptive threshold adjustment (ATA) circuit configured to adaptively modify a confidence threshold of the predictor circuit and/or a bandwidth ratio threshold of the ATA circuit to further fine-tune the accuracy of the usefulness predictions generated by the predictor circuit.

In another aspect, a hardware prefetch engine of a processor-based device is provided. The hardware prefetch engine comprises a sampler circuit that comprises a plurality of sampler set entries, each corresponding to a set of a plurality of sets of a cache. Each sampler set entry comprises a plurality of sampler line entries, each of which comprises a prefetch indicator and corresponds to a memory address indicated by one of a demand request and a prefetch request. The hardware prefetch engine further comprises a predictor circuit that comprises a plurality of confidence counters, each of which corresponds to a sampler line entry of the sampler circuit. The predictor circuit is configured to, responsive to a demand request hit on the sampler circuit, increment a confidence counter of the plurality of confidence counters corresponding to a sampler line entry of the sampler circuit corresponding to the demand request hit and having the prefetch indicator of the sampler line entry set. The predictor circuit is further configured to, responsive to the demand request hit on the sampler circuit, clear the prefetch indicator of the sampler line entry. The predictor circuit is also configured to, responsive to a demand request miss on the sampler circuit, decrement a confidence counter of the plurality of confidence counters corresponding to a sampler line entry of the sampler circuit evicted as a result of the demand request miss and having the prefetch indicator of the sampler line entry set. The predictor circuit is also configured to, responsive to a prefetch request, generate a usefulness prediction for the prefetch request based on comparing a value of a confidence threshold with a value of a confidence counter of the plurality of confidence counters corresponding to a sampler line entry of the sampler circuit identified by the prefetch request.

In another aspect, a hardware prefetch engine of a processor-based device is provided. The hardware prefetch engine comprises a means for providing a plurality of sampler set entries each corresponding to a set of a plurality of sets of a cache, and comprising a plurality of sampler line entries each comprising a prefetch indicator and corresponding to a memory address indicated by one of a demand request and a prefetch request. The hardware prefetch engine further comprises a means for incrementing a confidence counter of a plurality of confidence counters corresponding to a sampler line entry corresponding to a demand request hit and having the prefetch indicator of the sampler line entry set, responsive to the demand request hit. The hardware prefetch engine also comprises a means for clearing the prefetch indicator of the sampler line entry, responsive to the demand request hit. The hardware prefetch engine additionally comprises a means for decrementing a confidence counter of the plurality of confidence counters corresponding to a sampler line entry of the sampler circuit evicted as a result of a demand request miss and having the prefetch indicator of the sampler line entry set, responsive to the demand request miss. The hardware prefetch engine further comprises a means for generating a usefulness prediction for a prefetch request based on comparing a value of a confidence threshold with a value of a confidence counter of the plurality of confidence counters corresponding to a sampler line entry of the sampler circuit identified by the prefetch request, responsive to the prefetch request.

In another aspect, a method for predicting prefetch usefulness is provided. The method comprises, responsive to a demand request hit on a sampler circuit of a hardware prefetch engine of a processor-based device, the sampler circuit comprises a plurality of sampler set entries each corresponding to a set of a plurality of sets of a cache, and comprises a plurality of sampler line entries each comprising a prefetch indicator and corresponding to a memory address indicated by one of a demand request and a prefetch request. The method further comprises incrementing, by a predictor circuit of the hardware prefetch engine, a confidence counter of a plurality of confidence counters corresponding to a sampler line entry of the sampler circuit corresponding to the demand request hit and having the prefetch indicator of the sampler line entry set. The method further comprises, responsive to the demand request hit on the sampler circuit, clearing the prefetch indicator of the sampler line entry. The method also comprises, responsive to a demand request miss on the sampler circuit, decrementing, by the predictor circuit, a confidence counter of the plurality of confidence counters corresponding to a sampler line entry of the sampler circuit evicted as a result of the demand request miss and having the prefetch indicator of the sampler line entry set. The method additionally comprises, responsive to a prefetch request, generating, by the predictor circuit, a usefulness prediction for the prefetch request based on comparing a value of a confidence threshold with a value of a confidence counter of the plurality of confidence counters corresponding to a sampler line entry of the sampler circuit identified by the prefetch request.

### BRIEF DESCRIPTION OF THE FIGURES

FIG. 1 is a block diagram of an exemplary processor-based device including a hardware prefetch engine configured to predict usefulness of prefetches;

FIG. 2 is a block diagram of a sampler circuit of the hardware prefetch engine of FIG. 1 configured to store data for demand requests and prefetch requests for a subset of cache sets;

FIG. 3 is a block diagram of a predictor circuit of the hardware prefetch engine of FIG. 1 configured to track confidence levels for sampled data and generate usefulness predictions;

FIGS. 4A and 4B are flowcharts illustrating an exemplary process for training a predictor circuit in response to demand hits and misses on the sampler circuit;

FIGS. 5A and 5B are flowcharts illustrating an exemplary process that may be performed by a predictor circuit to generate a usefulness prediction in response to a received prefetch request;

FIG. 6 is a block diagram illustrating an adaptive threshold adjustment (ATA) circuit configured to modify a confidence threshold of a predictor circuit and/or a prediction accuracy threshold of the ATA circuit according to some aspects;

FIG. 7 is a flowchart illustrating an exemplary process that may be performed by the ATA circuit of FIG. 6 to adjust a confidence threshold of the predictor circuit according to some aspects;

FIG. 8 is a flowchart illustrating an exemplary process that may be performed by the ATA circuit in FIG. 6 to adjust a prediction accuracy threshold thereof according to some aspects; and

FIG. 9 is a block diagram of an exemplary processor-based device that can include the hardware prefetch engine of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

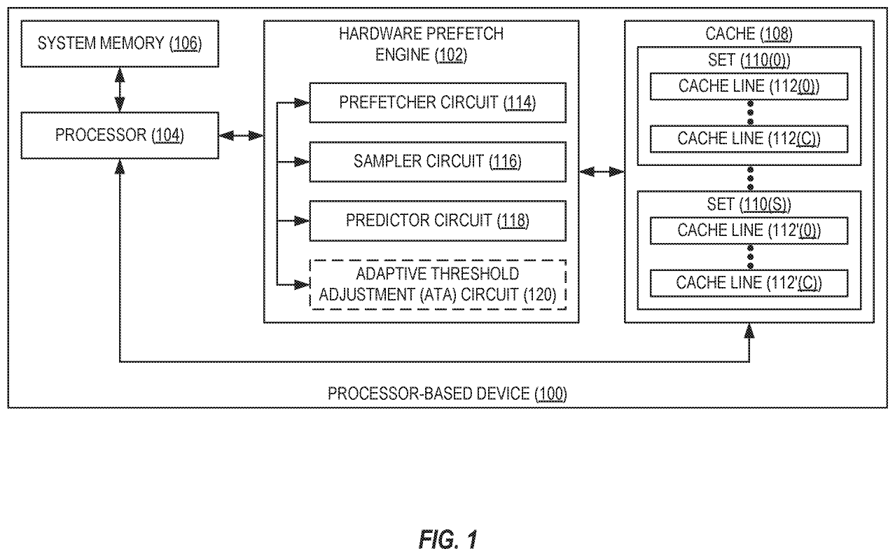

Aspects disclosed in the detailed description include adaptively predicting usefulness of prefetches generated by hardware prefetch engines in processor-based devices. Accordingly, in this regard, FIG. 1 is a block diagram of an exemplary processor-based device 100 that includes a hardware prefetch engine 102 configured to generate usefulness predictions for prefetch requests. The processor-based device 100 comprises a processor 104 that is communicatively coupled to the hardware prefetch engine 102 and to a system memory 106. The processor 104, in some aspects, may comprise one or more central processing units (CPUs), one or more processor cores, or one or more other processing elements (PEs), as known in the art. The system memory 106, according to some aspects, may comprise a double-rate dynamic random access memory (DRAM) (DDR), as a non-limiting example.

The processor-based device 100 further includes a cache 108 for caching frequently accessed data retrieved from the system memory 106 or from another, lower-level cache (i.e., a larger and slower cache, hierarchically positioned at a level between the cache 108 and the system memory 106). Thus, the cache 108 according to some aspects may comprise a Level 1 (L1) cache, a Level 2 (L2) cache, or another cache lower in a memory hierarchy. In the example of FIG. 1, the cache 108 is a set associative cache that is organized into a plurality of sets 110(0)-110(S) containing corresponding pluralities of cache lines 112(0)-112(C), 112′(0)-112′(C).

It is to be understood that the processor-based device 100 and the illustrated elements thereof may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages. It is to be further understood that aspects of the processor-based device 100 of FIG. 1 may include additional elements not illustrated in FIG. 1 and omitted for the sake of clarity.

The cache 108 of the processor-based device 100 may be used to provide speedier access to frequently-accessed data retrieved from the system memory 106 and/or from a higher-level cache (as in aspects in which the cache 108 is an L2 cache storing frequently accessed data from an L1 cache, as a non-limiting example). To minimize the number of cache misses that may be incurred by the cache 108, the processor-based device 100 also includes the hardware prefetch engine 102. The hardware prefetch engine 102 comprises a prefetcher circuit 114 that is configured to predict memory accesses and generate prefetch requests for the corresponding prefetch data (e.g., from the system memory 106 and/or from a higher-level cache). In some aspects in which memory access requests tend to exhibit spatial locality, the prefetcher circuit 114 of the hardware prefetch engine 102 may be configured to prefetch data from a next memory address after the memory address of a current memory access request. Some aspects may provide that the prefetcher circuit 114 of the hardware prefetch engine 102 is configured to detect patterns of memory access requests, and predict future memory access requests based on the detected patterns.

However, as noted above, if the prefetcher circuit 114 generates inaccurate prefetch requests, the overall system performance of the processor-based device 100 may be negatively impacted. For example, the cache 108 may suffer from cache pollution if prefetched data that is not actually useful causes the eviction of one or more of the cache lines 112(0)-112(C), 112′(0)-112′(C) that are storing useful data. Inaccurate prefetch requests also may increase consumption of power and memory bandwidth, without the benefit of the prefetched data being useful.

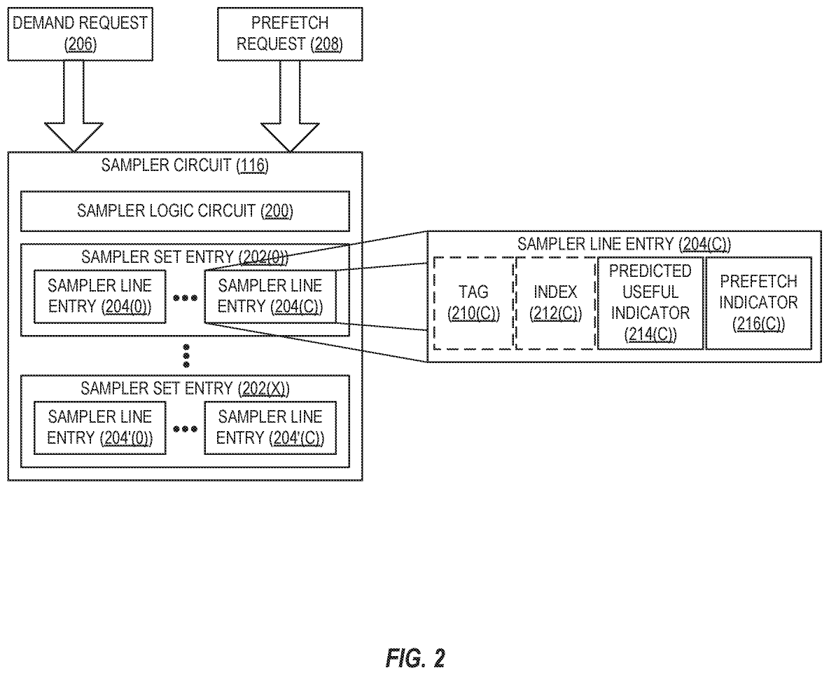

In this regard, the hardware prefetch engine 102 of the processor-based device 100 of FIG. 1 provides a mechanism for adaptively predicting the usefulness of prefetches generated by the prefetcher circuit 114, and to use such usefulness predictions to improve the accuracy of the hardware prefetch engine 102. In particular, the hardware prefetch engine 102 includes a sampler circuit 116 that is configured to store data related to both prefetch requests and demand requests to a sampled subset of the sets 110(0)-110(S) of the cache 108. The hardware prefetch engine 102 also includes a predictor circuit 118 that maintains a list of confidence counters corresponding to the data tracked by the sampler circuit 116. The predictor circuit 118 can then generate usefulness predictions for prefetch requests by comparing the confidence counters with a confidence threshold. Some aspects of the hardware prefetch engine 102 further include an adaptive threshold adjustment (ATA) circuit 120 that is configured to adjust the confidence threshold of the predictor circuit 118 based on a comparison of a misprediction rate with a prediction accuracy threshold, and may also adjust the prediction accuracy threshold based on actual memory access latency. Elements of the sampler circuit 116, the predictor circuit 118, and the ATA circuit 120 are discussed in greater detail below with respect to FIGS. 2, 3, and 6, respectively.

To illustrate elements of the sampler circuit 116 of FIG. 1 according to some aspects, FIG. 2 is provided. As seen in FIG. 2, the sampler circuit 116 includes a sampler logic circuit 200 configured to provide the functionality described herein for the sampler circuit 116. The sampler circuit 116 provides a plurality of sampler set entries 202(0)-202(X), which correspond to a specified subset of the sets 110(0)-110(S) of the cache 108. As a non-limiting example, each of the sampler set entries 202(0)-202(X) may correspond to every 16^{th} set of the sets 110(0)-110(S) of the cache 108. Each sampler set entry 202(0)-202(X) includes a plurality of sampler line entries 204(0)-204(C), 204′(0)-204′(C) that correspond to memory lines that would be stored in the cache lines 112(0)-112(C), 112′(0)-112′(C) of the sets 110(0)-110(S) that are sampled by the sampler set entries 202(0)-202(X).

To accurately mimic the activities of the cache 108, the sampler circuit 116 stores data related to the sets 110(0)-110(S) of the cache 108 that are targeted by either a demand request 206 or a prefetch request 208. Moreover, the sampler circuit 116 stores data related to both prefetch requests that are predicted useful (and thus result in prefetch data being retrieved and stored in the cache 108) as well as prefetch requests that are predicted useless (and thus are discarded without affecting the content of the cache 108). Accordingly, data may be inserted into the sampler circuit 116 in response to demand loads, prefetches predicted to be useful, and prefetches predicted to be useless.

To further illustrate data that may be stored within each of the sampler line entries 204(0)-204(C), 204′(0)-204′(C), FIG. 2 shows the internal structure of the exemplary sampler line entry 204(C). The sampler line entry 204(C) in some aspects includes a tag 210(C), an index 212(C), a predicted useful indicator 214(C), and a prefetch indicator 216(C). The tag 210(C) represents an identifier for the demand request 206 or the prefetch request 208 corresponding to the sampler line entry 204(C), and, according to some aspects, may comprise a subset of bits of a memory address of the demand request 206 or the prefetch request 208. The index 212(C) of the sampler line entry 204(C) stores an identifier that associates the sampler line entry 204(C) with a corresponding confidence counter maintained by the predictor circuit 118. In some aspects, the index 212(C) may represent a set of attributes that attempt to uniquely represent the context in which the demand request 206 or the prefetch request 208 occurred. For instance, the index 212(C) may be based on a program counter (PC) hashed with a branch history, a PC hashed with a load path history, a memory address region hashed with a load path history, or a combination thereof (e.g., a hash of a PC, a memory address region, and a load path history), as non-limiting examples. The predicted useful indicator 214(C) of the sampler line entry 204(C) stores an indicator representing whether the predictor circuit 118 has predicted the sampler line entry 204(C) to be useful or useless. Finally, the prefetch indicator 216(C) of the sampler line entry 204(C) indicates whether the sampler line entry 204(C) was established in response to the demand request 206 or the prefetch request 208. In this manner, the prefetch indicator 216(C) enables the predictor circuit 118 to distinguish between data stored in the sampler circuit 116 as a result of the demand request 206 versus data stored as a result of the prefetch request 208 for purposes of tracking confidence levels for prefetched data. It is to be understood that, although only the tag 210(C), the index 212(C), the predicted useful indicator 214(C), and the prefetch indicator 216(C) are illustrated in FIG. 2, the sampler line entries 204(0)-204(C), 204′(0)-204′(C) include the corresponding tags 210(0)-210(C), 210′(0)-210′(C), the corresponding indices 212(0)-212(C), 212′(0)-212′(C), the corresponding predicted useful indicators 214(0)-214(C), 214′(0)-214′(C), and the corresponding prefetch indicators 216(0)-216(C), 216′(0)-216′(C).

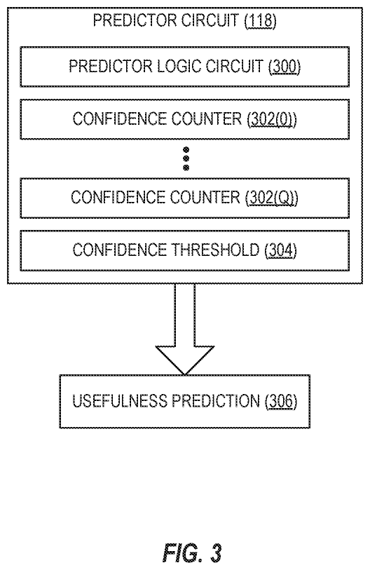

FIG. 3 illustrates constituent exemplary elements of the predictor circuit 118 for tracking confidence levels associated with data stored in the sampler circuit 116 and predicting the usefulness of prefetches. In the example of FIG. 3, the predictor circuit 118 provides a predictor logic circuit 300 that is configured to provide the functionality described herein for the predictor circuit 118. The predictor circuit 118 also includes confidence counters 302(0)-302(Q), which may be compared to a confidence threshold 304 to generate a usefulness prediction 306. The confidence counters 302(0)-302(Q) in some aspects may comprise saturating counters having a size of six (6) bits, and are indexed according to the same set of attributes used to generate the index 212(C) illustrated in FIG. 2. Some aspects may provide that the confidence counters 302(0)-302(Q) are initialized with a value of 16, while other aspects may initialize the confidence counters 302(0)-302(Q) with another empirically determined value.

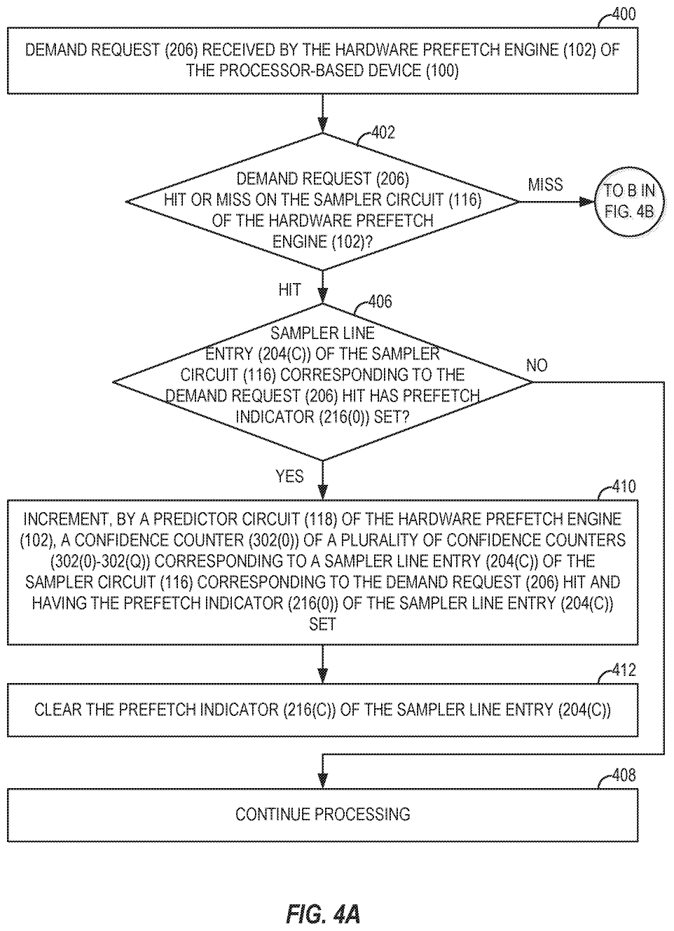

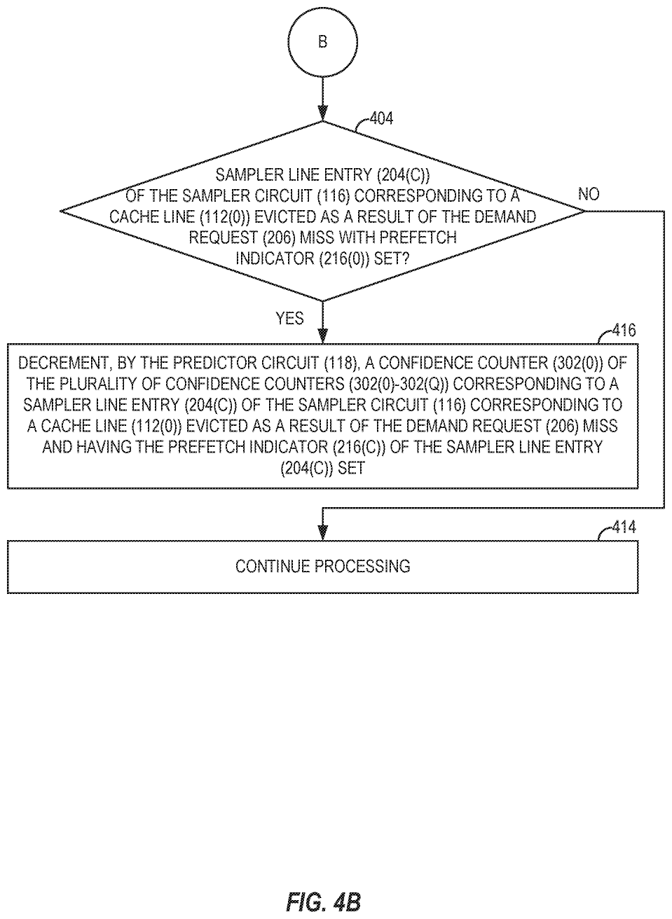

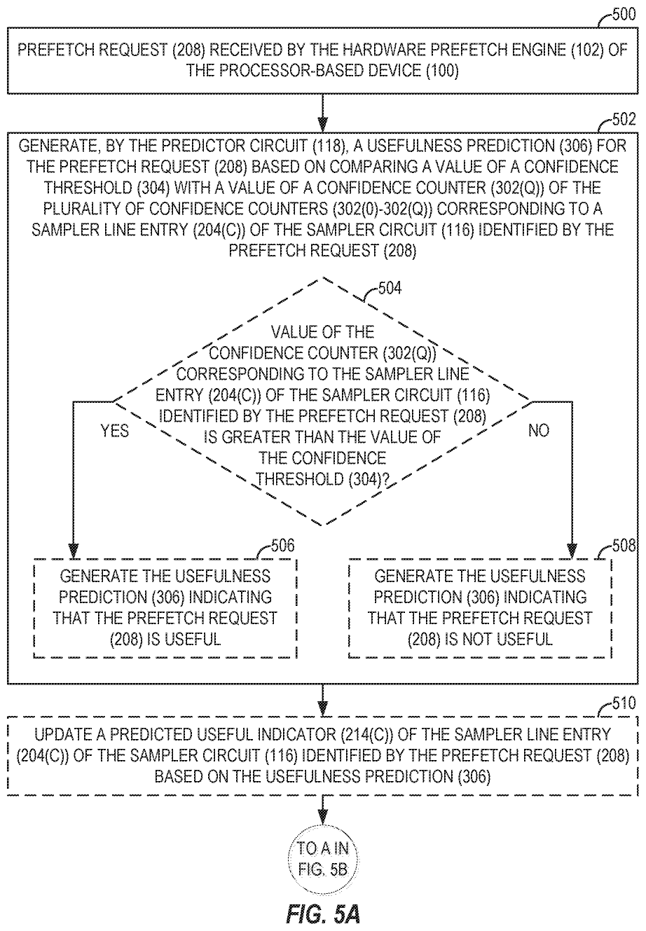

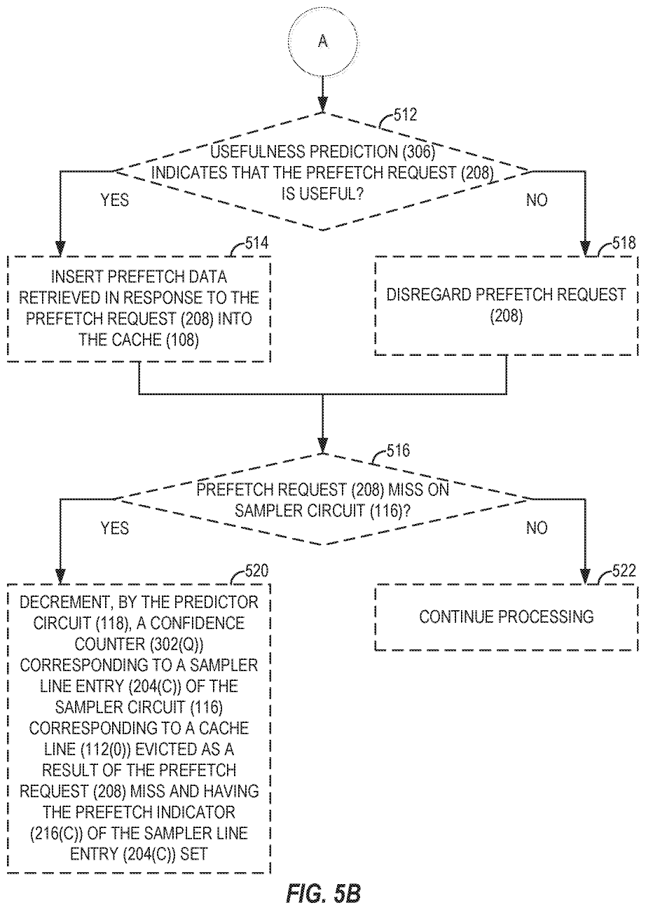

The confidence counters 302(0)-302(Q) are incremented or decremented by the predictor circuit 118 in response to a demand request hit or a demand request miss (resulting in an eviction) on the sampler circuit 116, and, in some aspects, in response to a prefetch request miss on the sampler circuit 116. This process of incrementing and decrementing the confidence counters 302(0)-302(Q) is referred to as “training” the predictor circuit 118, and is discussed in greater detail below with respect to FIGS. 4A and 4B. Similarly, the process for generating the usefulness prediction 306 in response to a prefetch request is discussed in greater detail below with respect to FIGS. 5A and 5B.

FIGS. 4A and 4B are flowcharts illustrating an exemplary process for training the predictor circuit 118 of FIGS. 1 and 3 in response to demand request hits and/or demand request misses on the sampler circuit 116 of FIGS. 1 and 2. For the sake of brevity, elements of FIGS. 1-3 are referenced in describing FIGS. 4A and 4B. Operations in FIG. 4A begin with the hardware prefetch engine 102 of the processor-based device 100 receiving a demand request, such as the demand request 206 of FIG. 2 (block 400). The demand request 206 may comprise a memory access request made by the processor 104 of the processor-based device 100. A determination is then made regarding whether the demand request 206 results in a hit or a miss on the sampler circuit 116 (i.e., whether the demand request 206 corresponds to one of the sampler line entries 204(0)-204(C), 204′(0)-204′(C) of the sampler set entries 202(0)-202(X) of the sampler circuit 116 (block 402). If the demand request 206 results in a miss, processing resumes at block 404 of FIG. 4B.

However, if it is determined at decision block 402 of FIG. 4A that the demand request 206 results in a hit on the sampler circuit 116 (e.g., on the sampler line entry 204(C) of the sampler circuit 116), a further determination is made regarding whether the sampler line entry 204(C) of the sampler circuit 116 corresponding to the demand request 206 hit has the corresponding prefetch indicator 216(C) set (thus indicating that the sampler line entry 204(C) was stored in the sampler circuit 116 in response to a prefetch request 208) (block 406). If not, processing continues at block 408.

If it is determined at decision block 402 of FIG. 4A that the prefetch indicator 216(C) of the sampler line entry 204(C) is set, then the sampler line entry 204(C) is considered to represent a useful prefetch. Thus, the predictor circuit 118 increments a confidence counter (such as the confidence counter 302(0) of the predictor circuit 118) of the plurality of confidence counters 302(0)-302(Q) corresponding to the sampler line entry 204(C) of the sampler circuit 116 corresponding to the demand request 206 hit and having the prefetch indicator 216(C) of the sampler line entry 204(C) set (block 410). In this regard, the predictor circuit 118 may be referred to herein as “a means for incrementing a confidence counter of a plurality of confidence counters corresponding to a sampler line entry corresponding to a demand request hit and having the prefetch indicator of the sampler line entry set, responsive to the demand request hit.” The predictor circuit 118 then clears the prefetch indicator 216(C) of the sampler line entry 204(C) (block 412). Accordingly, the predictor circuit 118 may be referred to herein as “a means for clearing the prefetch indicator of the sampler line entry, responsive to the demand request hit.” By clearing the prefetch indicator 216(C) in response to the demand request 206 hit, the predictor circuit 118 is able to track which sampler line entries 204 among the plurality of sampler line entries 204(0)-204(C), 204′(0)-204′(C) were stored in the sampler circuit 116 but were never targeted by a demand request 206.

Referring now to FIG. 4B, if a determination is made at decision block 402 of FIG. 4A that the demand request 206 results in a miss on the sampler circuit 116, then an eviction will be performed by the sampler circuit 116. Consequently, a further determination is made regarding whether the sampler line entry 204(C) of the sampler circuit 116 evicted as a result of the demand request 206 has the prefetch indicator 216(C) set (indicating that the sampler line entry 204(C) was established as a result of a prefetch request 208 but was never consumed by a demand request 206) (block 404). If not, processing continues at block 414. However, if it is determined at decision block 404 of FIG. 4B that the sampler line entry 204(C) evicted as a result of the demand request 206 has the prefetch indicator 216(C) set, then the sampler line entry 204(C) is considered to be a useless prefetch, and thus the corresponding confidence counter 302(0) will be decremented. Accordingly, the predictor circuit 118 decrements the confidence counter 302(0) of the plurality of confidence counters 302(0)-302(Q) corresponding to the sampler line entry 204(C) of the sampler circuit 116 evicted as a result of the demand request 206 miss and having the prefetch indicator 216(C) of the sampler line entry 204(C) set (block 416). The predictor circuit 118 thus may be referred to herein as “a means for decrementing a confidence counter of the plurality of confidence counters corresponding to a sampler line entry of the sampler circuit evicted as a result of a demand request miss and having the prefetch indicator of the sampler line entry set, responsive to the demand request miss.”

To illustrate an exemplary process that may be performed by the predictor circuit 118 of FIGS. 1 and 3 to use the plurality of confidence counters 302(0)-302(Q) to generate the usefulness prediction 306 in response to a received prefetch request 208, FIGS. 5A and 5B are provided. Elements of FIGS. 1-3 are referenced in describing FIGS. 5A and 5B for the sake of clarity. In FIG. 5A, operations begin with the hardware prefetch engine 102 of the processor-based device 100 receiving a prefetch request such as the prefetch request 208 (block 500). In response, the predictor circuit 118 generates the usefulness prediction 306 for the prefetch request 208 based on comparing a value of a confidence threshold 304 with a value of a confidence counter (such as the confidence counter 302(Q), as a non-limiting example) of the plurality of confidence counters 302(0)-302(Q) corresponding to the sampler line entry 204(C) of the sampler circuit 116 identified by the prefetch request 208 (block 502). In this regard, the predictor circuit 118 may be referred to herein as “a means for generating a usefulness prediction for the prefetch request based on comparing a value of a confidence threshold with a value of a confidence counter of the plurality of confidence counters corresponding to a sampler line entry of the sampler circuit identified by the prefetch request, responsive to the prefetch request.”

In some aspects, the operations of block 502 for generating the usefulness prediction 306 may include first determining whether a value of the confidence counter 302(Q) corresponding to the sampler line entry 204(C) of the sampler circuit 116 identified by the prefetch request 208 is greater than the value of the confidence threshold 304 (block 504). Accordingly, the predictor circuit 118 may be referred to herein as “a means for determining whether the value of the confidence counter corresponding to the sampler line entry of the sampler circuit identified by the prefetch request is greater than the value of the confidence threshold.” If the value of the confidence counter 302(Q) is determined at decision block 504 to be greater than the value of the confidence threshold 304, the predictor circuit 118 generates the usefulness prediction 306 indicating that the prefetch request 208 is useful (block 506). The predictor circuit 118 thus may be referred to herein as “a means for generating the usefulness prediction indicating that the prefetch request is useful, responsive to determining that the value of the confidence counter is greater than the value of the confidence threshold.” However, if the value of the confidence counter 302(Q) is not greater than the value of the confidence threshold 304, the predictor circuit 118 generates the usefulness prediction 306 indicating that the prefetch request 208 is not useful (block 508). In this regard, the predictor circuit 118 may be referred to herein as “a means for generating the usefulness prediction indicating that the prefetch request is not useful, responsive to determining that the value of the confidence counter is not greater than the value of the confidence threshold.”

In some aspects, the predictor circuit 118 may also update a predicted useful indicator 214(C) of the sampler line entry 204(C) of the sampler circuit 116 identified by the prefetch request 208 based on the usefulness prediction 306 (block 510). Accordingly, the predictor circuit 118 may be referred to herein as “a means for updating a predicted useful indicator of the sampler line entry identified by the prefetch request based on the usefulness prediction.” By updating the predicted useful indicator 214(C) based on the usefulness prediction 306, the predictor circuit 118 can track the disposition of sampler line entries 204(0)-204(C), sampler line entries 204′(0)-204′(C) to determine misprediction rates. Processing in some aspects may continue at block 512 of FIG. 5B.

Turning now to FIG. 5B, some aspects may provide that the predictor circuit 118 may determine whether the usefulness prediction 306 indicates that the prefetch request 208 is useful (block 512). If so, the predictor circuit 118 may insert prefetch data retrieved in response to the prefetch request 208 into the cache 108 (block 514). The predictor circuit 118 thus may be referred to herein as “a means for inserting prefetch data retrieved in response to the prefetch request into the cache, responsive to the usefulness prediction indicating that the prefetch request is useful.” Processing then resumes at block 516 of FIG. 5B. If the predictor circuit 118 determines at decision block 512 of FIG. 5B that the usefulness prediction 306 indicates that the prefetch request 208 is not useful, the predictor circuit 118 may disregard the prefetch request 208 (block 518). Processing then resumes at block 516 of FIG. 5B.

According to some aspects, the predictor circuit 118 may determine whether the prefetch request 208 results in a miss on the sampler circuit 116 (block 516). In such aspects, a miss on the sampler circuit 116 may cause the predictor circuit 118 to be trained in much the same way as if the demand request 206 results in a miss. Accordingly, the predictor circuit 118 decrements the confidence counter 302(Q) corresponding to the sampler line entry 204(C) of the sampler circuit 116 evicted as a result of the prefetch request 208 miss and having the prefetch indicator 216(C) of the sampler line entry 204(C) set (block 520). In this regard, the predictor circuit 118 may be referred to herein as “a means for decrementing a confidence counter corresponding to a sampler line entry of the sampler circuit evicted as a result of a prefetch request miss and having the prefetch indicator of the sampler line entry set, responsive to the prefetch request miss.” If the predictor circuit 118 determines at decision block 516 that the prefetch request 208 results in a hit on the sampler circuit 116, processing continues in conventional fashion (block 522).

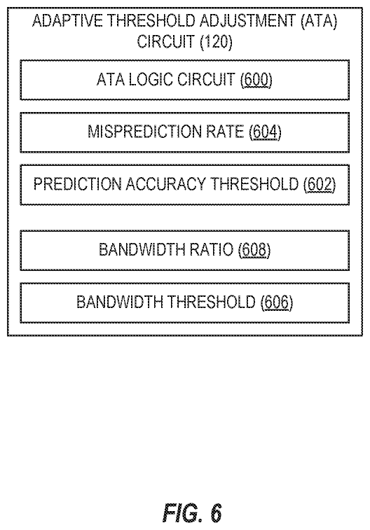

To illustrate exemplary elements of the ATA circuit 120 of FIG. 1 according to some aspects, FIG. 6 is provided. As noted above with respect to FIG. 1, such aspects of the hardware prefetch engine 102 may include the ATA circuit 120, which is configured to further fine-tune the accuracy of the usefulness prediction 306 generated by the predictor circuit 118 by adjusting the thresholds on which generation of the usefulness prediction 306 is based. As seen in FIG. 6, the ATA circuit 120 includes an ATA logic circuit 600 that provides the functionality of the ATA circuit 120 described herein. Some aspects of the ATA circuit 120 may use a prediction accuracy threshold 602 (with which a misprediction rate 604 of the predictor circuit 118 may be compared) to adaptively adjust the confidence threshold 304 of FIG. 3. Similarly, aspects of the ATA circuit 120 may also use a bandwidth threshold 606 (with which a bandwidth ratio 608 of actual memory access latency and expected memory access latency may be compared) to adaptively adjust the prediction accuracy threshold 602. In this manner, the ATA circuit 120 may enable the hardware prefetch engine 102 to adapt to dynamic conditions encountered during program execution.

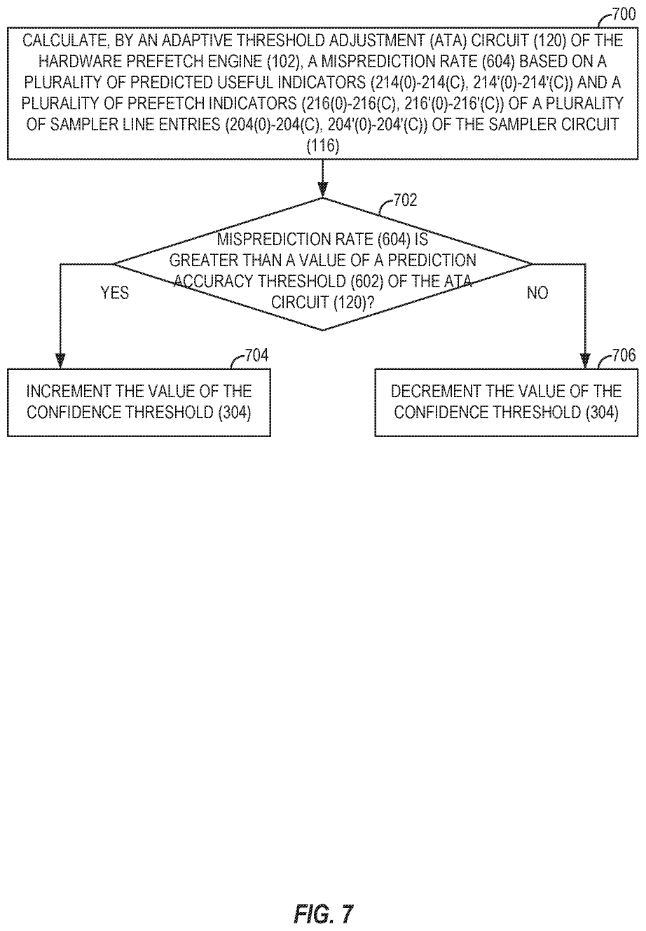

FIG. 7 illustrates exemplary operations that may be performed by the ATA circuit 120 to adjust the confidence threshold 304 of the predictor circuit 118 according to some aspects. For the sake of clarity, elements of FIGS. 1-3 and 6 are referenced in describing FIG. 7. Operations in FIG. 7 begin with the ATA circuit 120 calculating the misprediction rate 604 based on a plurality of predicted useful indicators 214(0)-214(C), 214′(0)-214′(C) and a plurality of prefetch indicators 216(0)-216(C), 216′(0)-216′(C) of a plurality of sampler line entries 204(0)-204(C), 204′(0)-204′(C) of the sampler circuit 116 (block 700). Accordingly, the ATA circuit 120 may be referred to herein as “a means for calculating a misprediction rate based on a plurality of predicted useful indicators and a plurality of prefetch indicators of the plurality of sampler line entries of the sampler circuit.”

In some aspects, operations of block 700 for calculating of the misprediction rate 604 may take place during an interval defined by a specified number of elapsed processor cycles or a specified number of executed instructions. The misprediction rate 604 in such aspects may be calculated by tracking a total number of mispredictions during this interval. For example, if the predicted useful indicator 214(C) for a sampler line entry 204(C) indicates that the sampler line entry 204(C) was considered useful, but the prefetch indicator 216(C) for the sampler line entry 204(C) indicates that the sampler line entry 204(C) was never targeted by a demand request 206 before eviction, the sampler line entry 204(C) is categorized as a misprediction, and the total number of mispredictions is incremented. Conversely, if the predicted useful indicator 214(C) for the sampler line entry 204(C) indicates that the sampler line entry 204(C) was considered not useful, but the prefetch indicator 216(C) for the sampler line entry 204(C) indicates that the sampler line entry 204(C) was consumed by a demand request 206, the sampler line entry 204(C) is categorized as a misprediction, and the total number of mispredictions is incremented. At the end of the interval, the total number of mispredictions may then be compared to a total number of predictions made during the interval to determine the misprediction rate 604.

Returning to FIG. 7, the ATA circuit 120 next determines whether the misprediction rate 604 is greater than a value of the prediction accuracy threshold 602 of the ATA circuit 120 (block 702). The ATA circuit 120 thus may be referred to herein as “a means for determining whether the misprediction rate is greater than a value of a prediction accuracy threshold.” If the ATA circuit 120 determines at decision block 702 that the misprediction rate 604 is greater than the value of the prediction accuracy threshold 602, the ATA circuit 120 increments the value of the confidence threshold 304 (block 704). In this regard, the ATA circuit 120 may be referred to herein as “a means for incrementing the value of the confidence threshold, responsive to determining that the misprediction rate is greater than the value of the prediction accuracy threshold.” If the misprediction rate 604 is not greater than the value of the prediction accuracy threshold 602, the ATA circuit 120 decrements the value of the confidence threshold 304 (block 706). Accordingly, the ATA circuit 120 may be referred to herein as “a means for decrementing the value of the confidence threshold, responsive to determining that the misprediction rate is not greater than the value of the prediction accuracy threshold.” Some aspects may provide that the confidence threshold 304 is restricted to a range specified by an upper limit above which the confidence threshold 304 will not be incremented, and a lower limit below which the confidence threshold 304 will not be decremented. As a non-limiting example, the confidence threshold 304 may be restricted to values within the range of eight (8) to 48.

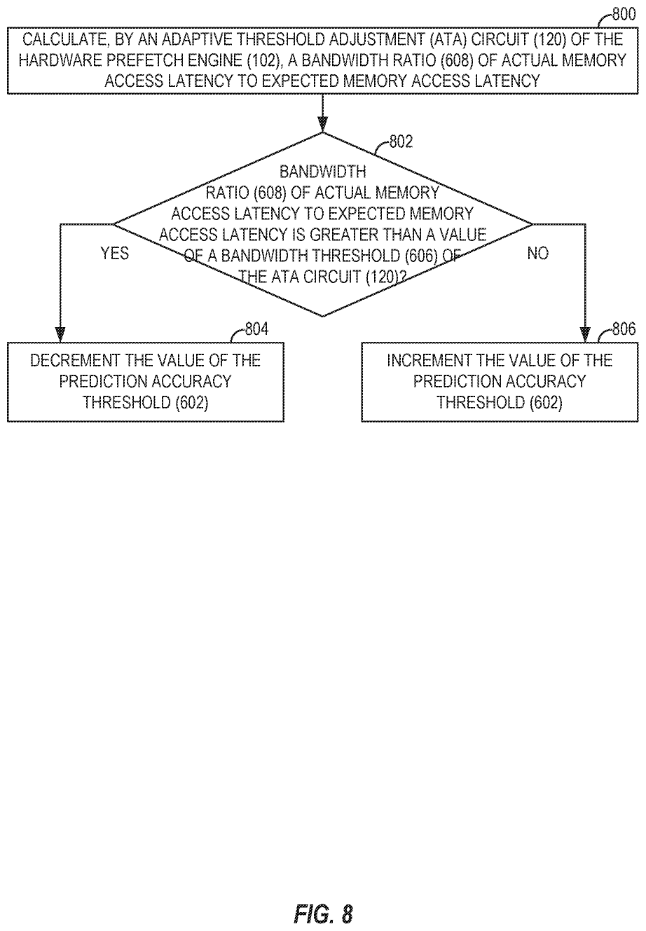

To illustrate exemplary operations that may be performed by the ATA circuit 120 to adjust the prediction accuracy threshold 602 of FIG. 6 in some aspects, FIG. 8 is provided. Elements of FIGS. 1-3 and 6 are referenced in describing FIG. 8 for the sake of clarity. In FIG. 8, operations begin with the ATA circuit 120 calculating the bandwidth ratio 608 of actual memory access latency to expected memory access latency (block 800). The ATA circuit 120 then determines whether the bandwidth ratio 608 of actual memory access latency to expected memory access latency is greater than a value of the bandwidth threshold 606 of the ATA circuit 120 (block 802). The ATA circuit 120 thus may be referred to herein as “a means for determining whether a bandwidth ratio of actual memory access latency to expected memory access latency is greater than a value of a bandwidth threshold.”

If it is determined at decision block 802 of FIG. 8 that the bandwidth ratio 608 of actual memory access latency to expected memory access latency is greater than the bandwidth threshold 606 (indicating that the processor-based device 100 is bandwidth-constrained), the ATA circuit 120 decrements the value of the prediction accuracy threshold 602 (block 804). In this regard, the ATA circuit 120 may be referred to herein as “a means for decrementing the value of the prediction accuracy threshold, responsive to determining that the bandwidth ratio of actual memory access latency to expected memory access latency is greater than the value of the bandwidth threshold.” By lowering the prediction accuracy threshold 602, the ATA circuit 120 further limits prefetch generation in bandwidth-constrained circumstances. However, if the bandwidth ratio 608 is not greater than the bandwidth threshold 606 (i.e., the processor-based device 100 is not bandwidth-constrained), the ATA circuit 120 increments the value of the prediction accuracy threshold 602 (block 804). Accordingly, the ATA circuit 120 may be referred to herein as “a means for incrementing the value of the prediction accuracy threshold, responsive to determining that the bandwidth ratio of actual memory access latency to expected memory access latency is not greater than the value of the bandwidth threshold.”

Adaptively predicting usefulness of prefetches generated by hardware prefetch engines in processor-based devices according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

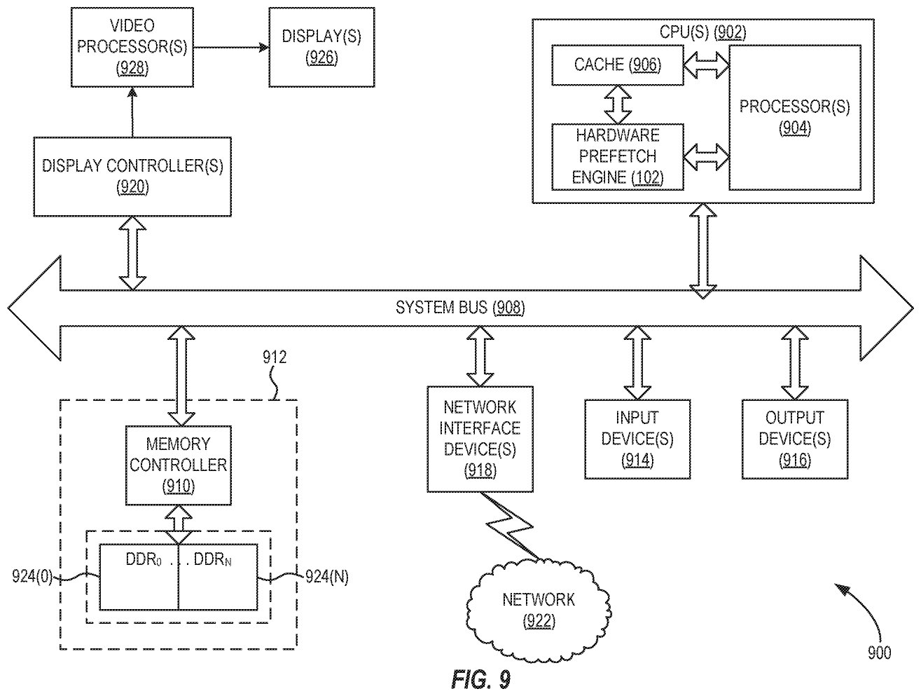

In this regard, FIG. 9 illustrates an example of a processor-based system 900 that may correspond to the processor-based device 100 of FIG. 1 in some aspects, and that may include the hardware prefetch engine 102 of FIG. 1. The processor-based system 900 includes one or more CPUs 902, each including one or more processors 904. The CPU(s) 902 may have cache memory 906 coupled to the processor(s) 904 for rapid access to temporarily stored data. The CPU(s) 902 is coupled to a system bus 908 and can intercouple master and slave devices included in the processor-based system 900. As is well known, the CPU(s) 902 communicates with these other devices by exchanging address, control, and data information over the system bus 908. For example, the CPU(s) 902 can communicate bus transaction requests to a memory controller 910 as an example of a slave device.

Other master and slave devices can be connected to the system bus 908. As illustrated in FIG. 9, these devices can include a memory system 912, one or more input devices 914, one or more output devices 916, one or more network interface devices 918, and one or more display controllers 920, as examples. The input device(s) 914 can include any type of input device, including but not limited to input keys, switches, voice processors, etc. The output device(s) 916 can include any type of output device, including, but not limited to, audio, video, other visual indicators, etc. The network interface device(s) 918 can be any devices configured to allow exchange of data to and from a network 922. The network 922 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 918 can be configured to support any type of communications protocol desired. The memory system 912 can include one or more memory units 924(0)-924(N).

The CPU(s) 902 may also be configured to access the display controller(s) 920 over the system bus 908 to control information sent to one or more displays 926. The display controller(s) 920 sends information to the display(s) 926 to be displayed via one or more video processors 928, which process the information to be displayed into a format suitable for the display(s) 926. The display(s) 926 can include any type of display, including, but not limited to, a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A hardware prefetch engine of a processor-based device, comprising:
a sampler circuit comprising a plurality of sampler set entries each corresponding to a set of a plurality of sets of a cache, and comprising a plurality of sampler line entries each comprising a prefetch indicator and corresponding to a memory address indicated by one of a demand request and a prefetch request; and
a predictor circuit comprising a plurality of confidence counters each corresponding to a sampler line entry of the sampler circuit and configured to:
responsive to a demand request hit on the sampler circuit:
increment a confidence counter of the plurality of confidence counters corresponding to a sampler line entry of the sampler circuit corresponding to the demand request hit and having the prefetch indicator of the sampler line entry set; and
clear the prefetch indicator of the sampler line entry;
responsive to a demand request miss on the sampler circuit:
decrement a confidence counter of the plurality of confidence counters corresponding to a sampler line entry of the sampler circuit evicted as a result of the demand request miss and having the prefetch indicator of the sampler line entry set; and
responsive to a prefetch request, generate a usefulness prediction for the prefetch request based on comparing a value of a confidence threshold with a value of a confidence counter of the plurality of confidence counters corresponding to a sampler line entry of the sampler circuit identified by the prefetch request.

2. The hardware prefetch engine of claim 1, wherein the predictor circuit is configured to generate the usefulness prediction for the prefetch request by being configured to:
determine whether the value of the confidence counter of the plurality of confidence counters corresponding to the sampler line entry of the sampler circuit identified by the prefetch request is greater than the value of the confidence threshold;
responsive to determining that the value of the confidence counter is greater than the value of the confidence threshold, generate the usefulness prediction indicating that the prefetch request is useful; and
responsive to determining that the value of the confidence counter is not greater than the value of the confidence threshold, generate the usefulness prediction indicating that the prefetch request is not useful.

3. The hardware prefetch engine of claim 2, wherein the predictor circuit is further configured to, responsive to the usefulness prediction indicating that the prefetch request is useful, insert prefetch data retrieved in response to the prefetch request into the cache.

4. The hardware prefetch engine of claim 2, wherein the predictor circuit is further configured to, responsive to a prefetch request miss on the sampler circuit, decrement a confidence counter of the plurality of confidence counters corresponding to a sampler line entry of the sampler circuit evicted as a result of the prefetch request miss and having the prefetch indicator of the sampler line entry set.

5. The hardware prefetch engine of claim 1, wherein:
each sampler line entry of the sampler circuit further comprises a predicted useful indicator; and
the predictor circuit is further configured to, subsequent to generating the usefulness prediction for the prefetch request, update the predicted useful indicator of the sampler line entry of the sampler circuit identified by the prefetch request based on the usefulness prediction.

6. The hardware prefetch engine of claim 5, further comprising an adaptive threshold adjustment (ATA) circuit comprising a prediction accuracy threshold and configured to:
calculate a misprediction rate based on a plurality of predicted useful indicators and a plurality of prefetch indicators of a plurality of sampler line entries of the sampler circuit;
determine whether the misprediction rate is greater than a value of the prediction accuracy threshold;
responsive to determining that the misprediction rate is greater than a value of the prediction accuracy threshold, increment the value of the confidence threshold; and
responsive to determining that the misprediction rate is not greater than a value of the prediction accuracy threshold, decrement the value of the confidence threshold.

7. The hardware prefetch engine of claim 6, wherein:
the ATA circuit further provides a bandwidth threshold; and
the ATA circuit is further configured to:
determine whether a bandwidth ratio of actual memory access latency to expected memory access latency is greater than a value of the bandwidth threshold;
responsive to determining that the bandwidth ratio of actual memory access latency to expected memory access latency is greater than the value of the bandwidth threshold, decrement the value of the prediction accuracy threshold; and
responsive to determining that the bandwidth ratio of actual memory access latency to expected memory access latency is not greater than the value of the bandwidth threshold, increment the value of the prediction accuracy threshold.

8. The hardware prefetch engine of claim 1 integrated into an integrated circuit (IC).

9. The hardware prefetch engine of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

10. A hardware prefetch engine of a processor-based device, comprising:
a means for providing a plurality of sampler set entries each corresponding to a set of a plurality of sets of a cache, and comprising a plurality of sampler line entries each comprising a prefetch indicator and corresponding to a memory address indicated by one of a demand request and a prefetch request;
a means for incrementing a confidence counter of a plurality of confidence counters corresponding to a sampler line entry corresponding to the demand request hit and having the prefetch indicator of the sampler line entry set, responsive to the demand request hit;
a means for clearing the prefetch indicator of the sampler line entry, responsive to the demand request hit;
a means for decrementing a confidence counter of the plurality of confidence counters corresponding to a sampler line entry of the sampler circuit evicted as a result of a demand request miss and having the prefetch indicator of the sampler line entry set, responsive to the demand request miss; and
a means for generating a usefulness prediction for a prefetch request based on comparing a value of a confidence threshold with a value of a confidence counter of the plurality of confidence counters corresponding to a sampler line entry of the sampler circuit identified by the prefetch request, responsive to the prefetch request.

11. The hardware prefetch engine of claim 10, wherein the means for generating the usefulness prediction for the prefetch request comprises:
a means for determining whether the value of the confidence counter corresponding to the sampler line entry of the sampler circuit identified by the prefetch request is greater than the value of the confidence threshold;
a means for generating the usefulness prediction indicating that the prefetch request is useful, responsive to determining that the value of the confidence counter is greater than the value of the confidence threshold; and
a means for generating the usefulness prediction indicating that the prefetch request is not useful, responsive to determining that the value of the confidence counter is not greater than the value of the confidence threshold.

12. The hardware prefetch engine of claim 11, further comprising a means for inserting prefetch data retrieved in response to the prefetch request into the cache, responsive to the usefulness prediction indicating that the prefetch request is useful.

13. The hardware prefetch engine of claim 12, further comprising a means for decrementing a confidence counter corresponding to a sampler line entry of the sampler circuit evicted as a result of a prefetch request miss and having the prefetch indicator of the sampler line entry set, responsive to the prefetch request miss.

14. The hardware prefetch engine of claim 10, further comprising a means for updating a predicted useful indicator of the sampler line entry identified by the prefetch request based on the usefulness prediction.

15. The hardware prefetch engine of claim 14, further comprising:
a means for calculating a misprediction rate based on a plurality of predicted useful indicators and a plurality of prefetch indicators of a plurality of sampler line entries of the sampler circuit;
a means for determining whether the misprediction rate is greater than a value of a prediction accuracy threshold;
a means for incrementing the value of the confidence threshold, responsive to determining that the misprediction rate is greater than the value of the prediction accuracy threshold; and
a means for decrementing the value of the confidence threshold, responsive to determining that the misprediction rate is not greater than the value of the prediction accuracy threshold.

16. The hardware prefetch engine of claim 15, further comprising:
a means for determining whether a bandwidth ratio of actual memory access latency to expected memory access latency is greater than a value of a bandwidth threshold;
a means for decrementing the value of the prediction accuracy threshold, responsive to determining that the bandwidth ratio of actual memory access latency to expected memory access latency is greater than the value of the bandwidth threshold; and
a means for incrementing the value of the prediction accuracy threshold, responsive to determining that the bandwidth ratio of actual memory access latency to expected memory access latency is not greater than the value of the bandwidth threshold.

17. A method for predicting prefetch usefulness, comprising:
responsive to a demand request hit on a sampler circuit of a hardware prefetch engine of a processor-based device, the sampler circuit comprising a plurality of sampler set entries each corresponding to a set of a plurality of sets of a cache, and comprising a plurality of sampler line entries each comprising a prefetch indicator and corresponding to a memory address indicated by one of a demand request and a prefetch request:
incrementing, by a predictor circuit of the hardware prefetch engine, a confidence counter of a plurality of confidence counters corresponding to a sampler line entry of the sampler circuit corresponding to the demand request hit and having the prefetch indicator of the sampler line entry set; and
clearing the prefetch indicator of the sampler line entry;
responsive to a demand request miss on the sampler circuit:
decrementing, by the predictor circuit, a confidence counter of the plurality of confidence counters corresponding to a sampler line entry of the sampler circuit evicted as a result of the demand request miss and having the prefetch indicator of the sampler line entry set; and
responsive to a prefetch request, generating, by the predictor circuit, a usefulness prediction for the prefetch request based on comparing a value of a confidence threshold with a value of a confidence counter of the plurality of confidence counters corresponding to a sampler line entry of the sampler circuit identified by the prefetch request.

18. The method of claim 17, wherein generating the usefulness prediction for the prefetch request comprises:
determining whether the value of the confidence counter corresponding to the sampler line entry of the sampler circuit identified by the prefetch request is greater than the value of the confidence threshold;
responsive to determining that the value of the confidence counter is greater than the value of the confidence threshold, generating the usefulness prediction indicating that the prefetch request is useful; and
responsive to determining that the value of the confidence counter is not greater than the value of the confidence threshold, generating the usefulness prediction indicating that the prefetch request is not useful.

19. The method of claim 18, further comprising, responsive to the usefulness prediction indicating that the prefetch request is useful, inserting prefetch data retrieved in response to the prefetch request into the cache.

20. The method of claim 17, further comprising, responsive to a prefetch request miss on the sampler circuit, decrementing, by the predictor circuit, a confidence counter corresponding to a sampler line entry of the sampler circuit evicted as a result of the prefetch request miss and having the prefetch indicator of the sampler line entry set.

21. The method of claim 17, further comprising, subsequent to generating the usefulness prediction for the prefetch request, updating a predicted useful indicator of the sampler line entry of the sampler circuit identified by the prefetch request based on the usefulness prediction.

22. The method of claim 21, further comprising:
calculating, by an adaptive threshold adjustment (ATA) circuit of the hardware prefetch engine, a misprediction rate based on a plurality of predicted useful indicators and a plurality of prefetch indicators of a plurality of sampler line entries of the sampler circuit;
determining whether the misprediction rate is greater than a value of a prediction accuracy threshold of the ATA circuit;
responsive to determining that the misprediction rate is greater than a value of the prediction accuracy threshold, incrementing the value of the confidence threshold; and
responsive to determining that the misprediction rate is not greater than a value of the prediction accuracy threshold, decrementing the value of the confidence threshold.

23. The method of claim 22, further comprising:
determining, by the ATA circuit, whether a bandwidth ratio of actual memory access latency to expected memory access latency is greater than a value of a bandwidth threshold of the ATA circuit;
responsive to determining that the bandwidth ratio of actual memory access latency to expected memory access latency is greater than the value of the bandwidth threshold, decrementing the value of the prediction accuracy threshold; and
responsive to determining that the bandwidth ratio of actual memory access latency to expected memory access latency is not greater than the value of the bandwidth threshold, incrementing the value of the prediction accuracy threshold.
